(19) United States
(12) Patent Application Publication
(10) Pub. No.: US 2004/0177898 A1
(43) Pub. Date: Sep. 16, 2004

(54) Method and means for corrosion preventive surface treatment of metals

(75) Inventor: Hans Magnusson, Kallered (SE)

Correspondence Address: LERNER, DAVID, LITTENBERG,, KRUMHOLZ & MENTLIK, 600 SOUTH AVENUE WEST, WESTFIELD, NJ, 07090, US

(73) Assignee: Altitech AB, Kallered (SE)

(21) Appl. No.: 10/715,959

(22) Filed: Nov. 18, 2003

Related U.S. Application Data
(63) Continuation-in-part of application No. 10/111,344, filed on Aug. 26, 2002.
Application No. 10/111,344 is a 371 of international application No. PCT/SE00/02075, filed on Oct. 24, 2000.

(30) Foreign Application Priority Data
Oct. 25, 1999 (SE) 9903828-3

(51) Int. Cl. C04B 9/02

(52) U.S. Cl. 148/255; 106/14.21; 148/262; 148/270

(57) ABSTRACT

Methods for treating metallic surfaces, such as aluminum and chromium alloys, are disclosed, including contacting the metallic surfaces with an aqueous solution containing a sulfate providing agent, such as sulfuric acid or alkali metal persulfate, an oxidizing agent for the sulfate providing agent, an alkali metal permanganate and an alkali metal carbonate, so as to provide a passivity surface layer on the metallic surface substantially comprising manganese, oxygen, sulfur and carbon. Aqueous solutions for providing these passivity layers are also disclosed.

### CROSS-REFERENCE TO RELATED APPLICATIONS

The present application is a continuation-in-part of U.S. application Ser. No. 10/111,344, filed on Aug. 26, 2002, the disclosure of which is incorporated by reference herein.

### BACKGROUND OF THE INVENTION

The present invention relates to a method for surface treatment of metals to provide the metal surface with a corrosion-protective layer. More particularly, the present invention relates to a combined agent for accomplishing a variant of the method through treatment baths in aqueous solutions. Still more particularly, the present invention relates to metal objects treated by means of the method of the present invention. According to one aspect of the present invention, an object thereof is to provide for retaining of the electrical conductivity of the treated metal surface.

A surface treatment of this kind is technically frequently termed passivation.

According to another aspect of the present invention, such a corrosive protective surface layer is further treated in order to form a base suitable for painting and gluing.

Aluminum and aluminum alloys are common construction materials, offering low weight and good workability. However, in most cases these materials have to be protected against corrosion.

A common method of doing so is anodizing, which provides for excellent corrosion protection, especially outdoors. The method utilized is electrolytic and is limited to electrically non-screened surfaces. This method provides an electrically insulating layer, and is therefore unsuitable if electrical conductivity is required.

Another common method for protecting aluminum and aluminum alloys against corrosion is chromating, which provides good protection against self-corrosion, preferably in indoor environments where condensing humidity might occur. Chromating provides very thin layers, about 1 μm, substantially consisting of chromium oxides and chromate salts. This type of surface treatment is commonly called passivation. Chromate layers provide an electrical conductivity that is sufficient in most cases. This property is of increasing importance, as a good electromagnetic screening is sought after in modern electronic applications. Another important property of chromate layers is to provide a good lacquer adhesion, especially for outdoor exposure. A modern paint application method is powder coating, placing even higher demands on the pretreatment, whereby chromating, preferably so-called yellow chromating, provides a perfectly satisfactory result. Chromating is a surface treatment method for aluminum and aluminum alloys that has major importance in technical applications.

Lately, however, the negative environmental properties of chromium combinations have attracted much attention. Such combinations are suspected to be allergenic and, in certain cases, carcinogenic. It is therefore important to find a replacement for chromating which has equally good technical properties, while at the same time neither causing any health hazards nor being detrimental to the exterior environment.

Other surface treatment methods, especially for aluminum, have therefore been searched for, which are capable of providing the same corrosion protection as chromating, but do not exhibit the adverse environmental properties thereof. One suggested method is thus to replace chromium with manganese; see U.S. Pat. No. 4,755,224 (Bibber). In this patent, treatment of the metal surface with alkali metal permanganate is suggested, for example potassium permanganate. According to the Bibber patent, a corrosion protection equal to that obtainable through chromating can be achieved, but with a treatment method and a result that are much more advantageous from an environmental viewpoint, as manganese does not exhibit the negative properties of chromium combinations as mentioned above.

However, the surface treatment method according to the Bibber patent requires a cumbersome procedure with treatment in several baths at a temperature of about 100° C. This makes the suggested process rather complex and thereby expensive, and is disadvantageous in terms of the work environment.

A further disadvantage connected to that treatment as well as other possible treatments resulting in a content of manganese in the surface layer, is that they result in a deterioration of the conditions for painting and gluing.

One object of the present invention is to provide a method through which an efficient corrosion protection can be achieved for objects made of aluminum, as well as for other corroding metals such as zinc, and for the alloys of such metals.

### SUMMARY OF THE INVENTION

This and other objects have now been realized by the discovery of a method of treating a metallic surface to provide an anticorrosive surface layer comprising contacting the metallic surface with an aqueous solution containing a sulfate providing agent, an oxidizing agent for the sulfate providing agent, an alkali metal permanganate, and an alkali metal carbonate so as to provide a passivating surface layer on the metallic surface substantially comprising manganese, oxygen, sulfur and carbon. Preferably, the sulfate providing agent is sulfuric acid or alkali metal persulfate.

In accordance with a preferred embodiment of the method of the present invention, the sulfate providing agent is sulfuric acid and the aqueous solution comprises a first aqueous solution comprising the sulfuric acid and the oxidizing agent, and a second aqueous solution comprising the alkali metal carbonate and the alkali metal permanganate. Preferably, the oxidizing agent comprises alkali metal permanganate or ammonium persulfate.

In accordance with one embodiment of the method of the present invention, the method includes pretreating the metallic surface with a degreasing step and/or a nonmetallic contaminant removal step, such as an oxide removal step. In accordance with a preferred embodiment of the method of the present invention, the first aqueous solution is provided by diluting 98% concentrated sulfuric acid to a concentration of between about 2 and 15 g/l of water, and preferably to a concentration of about 5 g/l of water. In accordance with another embodiment of the method of the present invention, the second aqueous solution includes the alkali metal carbonate at a concentration of from about 5 to 20 g/l of water, and preferably of about 10 g/l of water.

In accordance with another embodiment of the method of the present invention, the second aqueous solution includes the alkali metal permanganate at a concentration of between about 2 and 15 g/l of water, and preferably at a concentration of about 5 g/l of water.

In accordance with another embodiment of the method of the present invention, the first aqueous solution is maintained at a temperature of between about 20 and 25° C. In a preferred embodiment, the second aqueous solution is maintained at a temperature of between about 20 and 25° C.

In accordance with another embodiment of the method of the present invention, the sulfate providing agent comprises alkali metal sulfate. In a preferred embodiment, the oxidizing agent comprises alkali metal permanganate. In a preferred embodiment, the method includes providing the alkali metal persulfate, the alkali metal permanganate and the alkali metal carbonate in the form of powders, and preparing the aqueous solution from the powders.

In accordance with another embodiment of the method of the present invention, the method includes treating the passivating surface layer by reducing the passivating surface layer with an aqueous acid solution. Preferably, the aqueous acid solution comprises oxalic acid. In a preferred embodiment, the oxalic acid is maintained at a concentration of between about 5 and 50 g/l of water. Preferably, the oxalic acid solution is maintained at a temperature of between about 20 and 30° C.

In accordance with another embodiment of the method of the present invention, the pretreating comprises degreasing the metallic surface with an alkaline detergent, pickling in an aqueous solution of sodium hydroxide, neutralizing in an aqueous solution of nitric acid, and rinsing. Preferably, the degreasing is carried out at a temperature of between about 50 and 60° C. Preferably, the pickling is carried out using the sodium hydroxide at a concentration of between about 3 and 10%, and preferably about 5%. Preferably, the pickling is carried out at a temperature of between about 50 and 60° C.

Preferably, the neutralization is carried out using the nitric acid at a concentration of between about 10 and 30%, and preferably about 20%. Preferably, the rinsing is carried out using water.

In accordance with one embodiment of the method of the present invention, the metallic surface comprises an aluminum alloy intended for rolling or extrusion.

In accordance with another embodiment of the method of the present invention, the method includes pretreating the metallic surface by contacting the metallic surface with an aqueous solution of nitric acid, phosphoric acid, and hydrofluoric acid. Preferably, the metallic surface comprises an aluminum-based casting alloy. Preferably, the nitric acid is provided by diluting approximately 65% concentrated nitric acid to a concentration of about 150 ml/l of water. Preferably, the phosphoric acid is provided by diluting approximately 85% concentrated phosphoric acid to a concentration of about 800 ml/l of water. Preferably, the hydrofluoric acid is provided by diluting approximately 40% concentrated hydrofluoric acid to a concentration of about 50 ml/l of water.

In accordance with one embodiment of the method of the present invention, the alkali metal permanganate is provided at a concentration of between about 2 and 15 g/l of water, and preferably about 5 g/l of water. Preferably, the method is carried out at a temperature of between about 20 and 25° C. In one embodiment, the metallic surface comprises an aluminum alloy intended for rolling or extrusion.

In accordance with another embodiment of the method of the present invention, the ammonium persulfate is provided at a concentration of between about 20 and 60 g/l of water, and preferably about 40 g/l of water. Preferably, this method is carried out at a temperature of between about 20 and 25° C.

In accordance with another embodiment of the method of the present invention, the metallic surface comprises an aluminum-based casting alloy.

In accordance with another embodiment of the method of the present invention, the alkali metal permanganate and the alkali metal carbonate comprise potassium permanganate and potassium carbonate. In another embodiment, the alkali metal persulfate comprises potassium persulfate. In another embodiment, the alkali metal permanganate comprises potassium permanganate.

In accordance with the present invention, an aqueous solution has also been provided for treating a metallic surface to provide an anticorrosive surface comprising a sulfate providing agent, an oxidizing agent for the sulfate providing agent, an alkali metal permanganate, and an alkali metal carbonate whereby a passivating layer can be applied to the metallic surface substantially comprising manganese, oxygen, sulfur and carbon. Preferably, the sulfate providing agent is sulfuric acid or alkali metal persulfate. In a preferred embodiment, the sulfate providing agent comprises sulfuric acid and the aqueous solution comprises a first aqueous solution comprising the sulfuric acid and the oxidizing agent, and including a second aqueous solution comprising the alkali metal carbonate and the alkali metal permanganate. Preferably, the oxidizing agent comprises alkali metal permanganate or ammonium persulfate.

In accordance with a preferred embodiment of the aqueous solution of the present invention, the first aqueous solution comprises the sulfuric acid at a concentration of between about 2 and 15 g/l of water, and preferably about 5 g/l of water.

In accordance with a preferred embodiment of the aqueous solution of the present invention, the second aqueous solution comprises the alkali metal carbonate at a concentration of between about 5 and 20 g/l of water, and preferably about 10 g/l of water.

In accordance with another embodiment of the aqueous solution of the present invention, the second aqueous solution comprises the alkali metal permanganate at a concentration of between about 2 and 15 g/l of water, and preferably about 5 g/l of water.

In accordance with another embodiment of the aqueous solution of the present invention, the alkali metal permanganate and the alkali metal carbonate comprise potassium permanganate and potassium carbonate. In a preferred embodiment, the alkali metal persulfate comprises potassium persulfate. In another embodiment, the alkali metal permanganate comprises potassium permanganate.

In accordance with the present invention, a product has also been provided including a metallic surface having a passivating layer provided by the method set forth above.

The anticorrosion protection of the present invention is provided by a coating of the metal surface with a passivating layer containing manganese and without the use of chromium, this method being realized by a rational, simple process with only a few steps, using baths that can be held at room temperature. The invention also includes a combined agent advantageous to use for realizing this method. The method according to all embodiments of the invention can also include a pretreatment step, such as degreasing and removal of oxides and other contaminants.

The present treatment process for forming the surface layer hereof can be performed in two variations. In the first variation, means for the treatment are prepared by two chemical baths, a first acidiferous bath containing sulfuric acid and an oxidation agent for the sulfuric acid. Potassium or sodium permanganate is preferably used as oxidation agent. In some cases (see Example 2), ammonium persulfate is preferred. Through the oxidation of the sulfuric acid, a film containing sulfur and oxygen is obtained on the metal surface. The other bath for the second step of this treatment is alkaline containing, and alkali carbonate and potassium or sodium permanganate are preferably utilized. The temperature of the bath may be from about 20 to 25° C. Each bath may be prepared by adding the chemicals indicated above to water, thereby forming an aqueous solution. The sulfuric acid is added in liquid form, and the other chemicals in dry form.

In a second variation of the treatment of the present invention, only one bath is used. This single bath is prepared by forming an aqueous solution containing alkali permanganate, alkali carbonate and alkali persulfate. As the sulfuric agent, an alkali persulfate is utilized instead of sulfuric acid, and it is therefore possible to have all the chemicals in a dry form, which makes it much easier to prepare the solution. The chemicals can thus be mixed to form a powder mixture, from which the aqueous solution can be prepared by adding it to water.

According to another embodiment of the present invention, the layer formed by means of the described treatment, and containing manganese, is further treated with a reduction component in an acid solution. In this manner, the metal surface will obtain properties which make it suitable for painting and gluing.

The present invention also relates to metal objects having received a special surface layer provided by a treatment according to the above-described method.

### DETAILED DESCRIPTION

In the following description, some examples are provided for realization of the method according to the various embodiments of the present invention, and the various means used therefor. The stated examples relate, in part, to variants for application with different objects in terms of the metal and its alloying, and how its surface is constituted, whereas other examples state other potential variations in the treatment process within the scope of the present invention and the appended claims. The following examples are based on the treatment of aluminum.

Examples 1 and 2 relate to the first embodiment in its first variation of the treatment process of the present invention.

Example 1

Pretreatment is first carried out in order to obtain a clean metal surface, through degreasing and removal of oxides and other contaminants, i.e. pickling. The pretreatment stated below is preferably applied with such aluminum alloys as are used in production by means of rolling and extrusion, that is for sheets and profiles, respectively:

degreasing in an alkaline detergent at an elevated temperature of from about 50 to 60° C.,

pickling in an aqueous solution of sodium hydroxide at a concentration of about 5%, and at an elevated temperature of from about 50 to 60° C.,

neutralization in dilute nitric acid, at a concentration of about 20%,

rinsing in cold or warm water.

Surface treatment, step 1:

This treatment is performed in direct connection to the pretreatment step, in a water bath containing:

concentrated sulfuric acid, in an amount of from about 2 to 15 g/l of water, preferably about 5 g/l of water,

potassium permanganate, in an amount of from about 2 to 15, preferably about 5 g/l of water. The bath is held at a temperature of from about 20 to 25° C.

Treatment of the objects is performed by submerging them in the bath for a time span of about 5 to 10 minutes.

Surface treatment step 2:

This step is performed in a water bath containing:

potassium carbonate, at a concentration of from but 5 to 20, and preferably about 10 g/l of water,

potassium permanganate, at a concentration of from but 2 to about 15, preferably about 5 g/l of water. The bath is held at a temperature of from about 20 to 25° C.

Treatment of the objects is performed by submerging them in the bath for a time span of about 5 to 10 minutes. Rinsing is then performed in warm water, at a temperature of about 50° C., and in cold water.

### EXAMPLE 1

The chemical process which takes place can be expressed by means of the following formula:

20A(+15H₂SO₄+10KMnO₄→10Al₂O₃+5K₂SO₄+10MnSO₄+10H₂O+5H₂); 10Al₂O₃+4K2CO₃+4KMnO₄+12H₂O→4Al₂O₃.CO₂+4MnO₂+12KAl(OH)₂.O+3O₂

### EXAMPLE 2

### Pretreatment

The process is intended for pretreatment of objects made from casting alloys. These normally contain high concentrations of silicon, which has to be removed from the surface.

The following active components are to be included in a water bath:

approximately 65% concentrated nitric acid provided at a concentration of about 150 ml/l of water,

approximately 85% concentrated phosphoric acid provided at a concentration of about 800 ml/l of water,

approximatelyy 40% hydrofluoric acid provided at a concentration of about 50 ml/l of water.

The bath is preferably held at a temperature of from about 20 to 2520 C. and the treatment time should be about 2 to 5 minutes.

Finally, a careful rinsing is performed in warm water, at a temperature of about 50° C., and then in cold water.

### Surface Treatment Step 1

The following components are to be included in a water bath:

approximately 98% sulfuric acid provided at a concentration of about 10 g/l of water

ammonium persulfate, provided at a concentration of about 40 g/l of water.

The bath is held at a temperature of from about 20 to 25° C. and the treatment time should be about 5 to 10 minutes.

A careful rinsing is then performed in warm water, at a temperature of about 50° C., and then in cold water.

### Surface Treatment Step 2

The following components are to be included in a water bath:

potassium carbonate, provided at a concentration of from about 5 to 20, and preferably from about 10 g/l of water,

potassium permanganate, provided at a concentration of from about 2 to 15, and preferably about 5 g/l of water.

The bath is held at a temperature of from about 20 to 25° C. The treatment time should be about 5 to 10 minutes.

Finally, a careful rinsing is performed in warm water, at a temperature of about 50° C., and then in cold water. The chemical process can be expressed by means of the following formula:

20A(+10(NH₄)₂S₂O₈+30H₂O→10Al₂O₃+10(NH₄)₂SO₄+10H₂SO₄+20H₂10Al₂O₃+4K₂CO₃+4KMnO₄+12 H₂O→4Al₂O₃.CO₂+4MnO₂+12KAl(OH)₂+3 O_{2;}

The following example 3 relates to the second variation of the first embodiment of the treatment process herein.

### EXAMPLE 3

For the pretreatment in this example, in order to obtain a clean surface, the process described in Example 1 or 2 can be used, and selected with consideration to the type of aluminum which is to be treated.

In the surface treatment step, the chemicals to be contained in the bath are

Alkali permanganate, one part by weight;

Alkali persulfate, preferably potassium persulfate, two parts by weight;

Alkali carbonate preferably potassium carbonate, one part by weight.

These chemicals are pulverized in their powder form in order to be easily soluble. In this form the chemicals can be stored in dry condition, and they can be readily distributed to the place of use.

The treatment bath is then prepared by the chemicals being dissolved in water, preferably at a concentration of about 20 g/l of the water. A suitable water temperature is from about 20 to 30° C.

Rinsing in cold or warm water is then carried out. The treatment, like the treatments according to Examples 1 and 2, results in a passivating layer on the aluminum surface consisting of the elements manganese, oxygen, sulfur and carbon.

The chemical process can be expressed by means of the following formula:

6Al+2KMnO₄+2K₂CO₃+2K₂S₂O₈+6H₂O 2Al₂O₃.C0₂+2MnO₂+4K₂SO₄+2KAl(OH)₂.O+4H₂

In the examples, potassium has been stated as the preferred alkali metal. Other alkali metals may also be used as a compound together with permanganate carbonate and persulfate respectively, and preferably sodium. Such a change to an alkali metal other than potassium does not entail any substantial modifications of the procedures, or of the composition of the agents utilized, as stated in the examples. Considering its availability and ease of handling in an industrial environment, potassium is preferred.

The preliminary pretreatment steps and the composition of the agents stated in the examples are not of vital importance for the realization of the present invention. Within the known art, there are examples of other methods and agents for the preparation of the metal surface before the following steps. The preliminary steps stated in the examples have been found to yield a good result, but the present invention is not bound to the procedures stated in the examples, at least as far as the pretreatment steps are concerned.

In the surface treatment step 1, examples 1 and 2 sulfur is present in the form of sulfuric acid, which is of major importance in this context, as this sulfur will activate the surface and will be included, after oxidation of the sulfuric acid in step 1, in the passivating layer created in step 2. In Example 1, relating to common aluminum alloys for the manufacture of sheets and profiles, potassium permanganate is stated as the oxidation agent. In Example 2, relating to the treatment of casting alloys in which alloying constituents such as silicon, copper and iron are included, ammonium persulfate is stated as the oxidation agent.

For step 2, it is stated in both examples 1and 2 that the bath comprises potassium carbonate and potassium permanganate. In this manner, the passivating surface layer is finally created, in which manganese is included as the main component. The potassium carbonate contributes to the layer with the components carbon and oxygen. In step 1, the surface is prepared, through oxidation, for formation of the final layer in step 2. Furthermore, sulfur is supplied by the sulfuric acid utilized in both Examples 1and 2. In the only step stated in Example 3 the oxidation agent comprising sulfur is alkali persulfate. The passivating layer will, after the treatment stated in either of the examples, be composed of the elements manganese, oxygen, carbon and sulfur. This composition of the surface layer will thus characterize the finished, treated object.

The surface layer created by the surface treatment in either of its variations and according to the first embodiment of the present invention will provide good protection against corrosion in an aggressive environment. The description of the present invention has been directed towards corrosion protection of aluminum, and examples have been given for two types of aluminum alloy intended for objects produced by rolling or extrusion and through casting, respectively. Other metals also display corrosion properties similar to those of aluminum, especially zinc. The present invention is thus not limited to application with aluminum, even if treatment of this material is the most important area of application. Within the scope of the present invention will also lie its application for corrosion protection of other metals than aluminum and then primarily zinc, including some of its alloys.

The following Example 4 relates to the second embodiment of the present invention.

### EXAMPLE 4

The treatment according to the present example is a completion treatment of aluminum objects provided with a surface layer containing manganese by means of a treatment process described in any of Examples 1-3.

For the completion treatment a bath comprising a reduction component in an acid water solution is provided. The component is preferably oxalic acid in an amount as follows:

oxalic acid, at a concentration of from about 5 to 50 g/l of water, at a water temperature of about 20 to 30° C., for about 5 min.

Rinsing in cold or warm water is then carried out.

The chemical process can be expressed by means of the following formula:

MnO₂+2H₂C₂O₄→MnC₂O₄+2CO₂+2H₂O

As mentioned in the foregoing discussion, the goal of the completion treatment is to prepare the aluminum surface for painting and gluing by providing the surface with a good adhesive capacity by having good wetting properties for wet paint and powder coating compositions and for glues and adhesives used in industrial production.

In this manner, the suitability for painting and gluing by surfaces treated according to the present invention will be as good as the corresponding properties of chromatized or anodized surface without the disadvantages connected to these treatment methods.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A method of treating a metallic surface to provide an anticorrosive surface layer comprising contacting said metallic surface with an aqueous solution containing a sulfate providing agent, an oxidizing agent for said sulfate providing agent, an alkali metal permanganate, and an alkali metal carbonate so as to provide a passivating surface layer on said metallic surface substantially comprising manganese, oxygen, sulfur and carbon.

2. The method of claim 1 wherein said sulfate providing agent is selected from the group consisting of sulfuric acid and alkali metal persulfate.

3. The method of claim 1 wherein said sulfate providing agent comprises sulfuric acid and wherein said aqueous solution comprises a first aqueous solution comprising said sulfuric acid and said oxidizing agent, and including a second aqueous solution comprising said alkali metal carbonate and said alkali metal permanganate.

4. The method of claim 3 wherein said oxidizing agent comprises alkali metal permanganate.

5. The method of claim 3 wherein said oxidizing agent comprises ammonium persulfate.

6. The method of claim 1 including pretreating said metallic surface with a process selected from the group consisting of degreasing and nonmetallic contaminant removal.

7. The method of claim 6 wherein said nonmetallic contaminant removal comprises oxide removal.

8. The method of claim 3 wherein said first aqueous solution is provided by diluting 98% concentrated sulfuric acid to a concentration of between about 2 and 15 g/l of water.

9. The method of claim 8 wherein said first aqueous solution is provided by diluting 98% concentrated sulfuric acid to a concentration of about 5 g/l of water.

10. The method of claim 3 wherein said second aqueous solution includes said alkali metal carbonate at a concentration of from about 5 to 20 g/l of water.

11. The method of claim 10 wherein said second aqueous solution includes said alkali metal carbonate at a concentration of about 10 g/l of water.

12. The method of claim 3 wherein said second aqueous solution includes said alkali metal permanganate at a concentration of between about 2 and 15 g/l of water.

13. The method of claim 12 wherein said second aqueous solution includes said alkali metal permanganate at a concentration of about 5 g/l of water.

14. The method of claim 3 wherein said first aqueous solution is maintained at a temperature of between about 20 and 25° C.

15. The method of claim 14 wherein said second aqueous solution is maintained at a temperature of between about 20 and 25° C.

16. The method of claim 1 wherein said sulfate providing agent comprises alkali metal sulfate.

17. The method of claim 16 wherein said oxidizing agent comprises alkali metal permanganate.

18. The method of claim 17 including providing said alkali metal persulfate, said alkali metal permanganate and said alkali metal carbonate in the form of powders, and preparing said aqueous solution from said powders.

19. The method of claim 1 including treating said passivating surface layer by reducing said passivating surface layer with an aqueous acid solution.

20. The method of claim 19 wherein said aqueous acid solution comprises oxalic acid.

21. The method of claim 20 wherein said oxalic acid is maintained at a concentration of between about 5 and 50 g/l of water.

22. The method of claim 21 wherein said oxalic acid solution is maintained at a temperature of between about 20 and 30° C.

23. The method of claim 6 wherein said pretreating comprises degreasing said metallic surface with an alkaline detergent, pickling in an aqueous solution of sodium hydroxide, neutralizing in an aqueous solution of nitric acid, and rinsing.

24. The method of claim 23 wherein said degreasing is carried out at a temperature of between about 50 and 60° C.

25. The method of claim 23 wherein said pickling is carried out using said sodium hydroxide at a concentration of between about 3 and 10%.

26. The method of claim 25 wherein said pickling is carried out using said sodium hydroxide as a concentration of about 5%.

27. The method of claim 25 wherein said pickling is carried out at a temperature of between about 50 and 60° C.

28. The method of claim 23 wherein said neutralization is carried out using said nitric acid at a concentration of between about 10 and 30%.

29. The method of claim 28 wherein said neutralization is carried out using said nitric acid at a concentration of about 20%.

30. The method of claim 23 wherein said rinsing is carried out using water.

31. The method of claim 23 wherein said metallic surface comprises an aluminum alloy intended for rolling or extrusion.

32. The method of claim 1 including pretreating said metallic surface by contacting said metallic surface with an aqueous solution of nitric acid, phosphoric acid, and hydrofluoric acid.

33. The method of claim 32 wherein said metallic surface comprises an aluminum-based casting alloy.

34. The method of claim 32 wherein said nitric acid is provided by diluting approximately 65% concentrated nitric acid to a concentration of about 150 ml/l of water.

35. The method of claim 32 wherein said phosphoric acid is provided by diluting approximately 85% concentrated phosphoric acid to a concentration of about 800 ml/l of water.

36. The method of claim 32 wherein said hydrofluoric acid is provided by diluting approximately 40% concentrated hydrofluoric acid to a concentration of about 50 ml/l of water.

37. The method of claim 4 wherein said alkali metal permanganate is provided at a concentration of between about 2 and 15 g/l of water.

38. The method of claim 37 wherein said alkali metal permanganate is provided at a concentration of about 5 g/l of water.

39. The method of claim 37 carried out at a temperature of between about 20 and 25° C.

40. The method of claim 37 wherein said metallic surface comprises an aluminum alloy intended for rolling or extrusion.

41. The method of claim 5 wherein said ammonium persulfate is provided at a concentration of between about 20 and 60 g/l of water.

42. The method of claim 41 wherein said ammonium persulfate is provided at a concentration of about 40 g/l of water.

43. The method of claim 41 carried out at a temperature of between about 20 and 25° C.

44. The method of claim 41 wherein said metallic surface comprises an aluminum-based casting alloy.

45. The method of claim 1 wherein said alkali metal permanganate and said alkali metal carbonate comprise potassium permanganate and potassium carbonate.

46. The method of claim 2 wherein said alkali metal persulfate comprises potassium persulfate.

47. The method of claim 4 wherein said alkali metal permanganate comprises potassium permanganate.

48. An aqueous solution for treating a metallic surface to provide an anticorrosive surface comprising a sulfate providing agent, an oxidizing agent for said sulfate providing agent, an alkali metal permanganate, and an alkali metal carbonate whereby a passivating layer can be applied to said metallic surface substantially comprising manganese, oxygen, sulfur and carbon.

49. The aqueous solution of claim 48 wherein said sulfate providing agent is selected from the group consisting of sulfuric acid and alkali metal persulfate.

50. The aqueous solution of claim 48 wherein said sulfate providing agent comprises sulfuric acid and wherein said aqueous solution comprises a first aqueous solution comprising said sulfuric acid and said oxidizing agent, and including a second aqueous solution comprising said alkali metal carbonate and said alkali metal permanganate.

51. The aqueous solution of claim 50 wherein said oxidizing agent comprises alkali metal permanganate.

52. The aqueous solution of claim 50 wherein said oxidizing agent comprises ammonium persulfate.

53. The aqueous solution of claim 50 wherein said first aqueous solution comprises said sulfuric acid at a concentration of between about 2 and 15 g/l of water.

54. The aqueous solution of claim 53 wherein said first aqueous solution comprises said sulfuric acid at a concentration of about 5 g/l of water.

55. The aqueous solution of claim 50 wherein said second aqueous solution comprises said alkali metal carbonate at a concentration of between about 5 and 20 g/l of water.

56. The aqueous solution of claim 55 wherein said second aqueous solution comprises said alkali metal carbonate at a concentration of about 10 g/l of water.

57. The aqueous solution of claim 50 wherein said second aqueous solution comprises said alkali metal permanganate at a concentration of between about 2 and 15 g/l of water.

58. The aqueous solution of claim 57 wherein said second aqueous solution comprises said alkali metal permanganate at a concentration of about 5 g/l of water.

59. The aqueous solution of claim 48 wherein said alkali metal permanganate and said alkali metal carbonate comprise potassium permanganate and potassium carbonate.

60. The aqueous solution of claim 49 wherein said alkali metal persulfate comprises potassium persulfate.

61. The aqueous solution of claim 51 wherein said alkali metal permanganate comprises potassium permanganate.

62. A product including a metallic surface having a passivating layer provided by the method of claim 1.
